(19) United States
(12) Patent Application Publication
(10) Pub. No.: US 2011/0226721 A1
(43) Pub. Date: Sep. 22, 2011

(54) THREADED CLOSURE ASSEMBLY

(76) Inventors: Richard Lawrence Horstman, Cincinnati, OH (US); Bradley Scott Neufarth, Loveland, OH (US); Kerry Lloyd Weaver, Florence, KY (US); Alfredo Pagan, Mason, OH (US)

(21) Appl. No.: 13/010,931

(22) Filed: Jan. 21, 2011

(30) Foreign Application Priority Data
Feb. 1, 2010 (CA) 2689924

(51) Int. Cl. B65D 51/00; B65D 41/04; B67B 3/20

(52) U.S. Cl. 215/230; 215/329; 53/490

(57) ABSTRACT

A threaded closure assembly comprising a transition and a cap is disclosed. The threaded closure assembly may be utilized to seal a liquid containing bottle, particularly one containing a liquid fabric composition.

### FIELD OF THE INVENTION

The present invention relates to caps and to the threaded closure assemblies of which they may form a part.

### BACKGROUND OF THE INVENTION

Threaded caps and transitions are used in various industries as bottle closures. The cap characteristics may impact the amount of force and/or the number of cap revolutions required to seal or open a closed bottle with the cap. Such characteristics include, but are not limited to the number of thread leads and the thread lead angle.

The importance of thread characteristics in the field of mass produced bottles is evident throughout the useful life of the bottle. For example, when bottles are initially made on high speed manufacturing lines, it is important for the caps to be rapidly registered and mutually engaged with the transition threads to close the bottle. Additionally, enough torque must be applied to the cap in order to form a seal between the cap and the transition, otherwise, the cap can back off, allowing for the bottle contents to leak out during storage and/or transport. Yet when the bottle reaches the consumer, he or she must be able to readily open the bottle, and in some instances, to reseal it for future use. These characteristics are of especial import in the area of liquid laundry detergents given the frustrations that can be associated with being unable to dispense the liquid from the bottle, and/or the liquid leaking from the bottle to cause a mess.

Some commercially available caps, such as the cap 10 shown in FIG. 1, comprise one discontinuous thread 11, which necessarily has one lead 12. To close a bottle with this cap, it may be necessary to rotate the cap as many as about 1.5 times. This can be undesirable for at least two reasons. First, rotating a cap multiple times to close a bottle may not be efficient as it can waste precious time on a high speed manufacturing line where every second counts. Second, it may make it difficult for individuals with arthritis and other afflictions to effect the twisting motion that is necessary to rotate the cap multiple times to obtain a tight closure.

Some commercially available caps, such as the cap 20 shown on the bottle 200 pictured in FIG. 2, are “top heavy”, meaning that when the bottle is closed, the cap sticks out high above the bottle opening. Aside from being aesthetically unappealing, this can be undesirable from a practical standpoint, because it can require more shipping and shelf space than a similar sized bottle having a shorter cap. One approach to overcoming these disadvantages would be to hold the volume of the cap constant, while expanding the diameter of the cap. This would result in a shorter, more squat cap. Yet when the same amount of liquid is placed in a shorter, squat cap, it may appear that less liquid is present than in a taller cap having the same volume, but a smaller diameter. This can be disadvantageous in the areas of compacted detergents since it may lead the consumer to assume that the dosage of a product is too skimpy.

Some commercially available caps, such as the cap 10 shown in FIG. 1 or the cap 30 shown in FIG. 3, respectively comprise threads (11 and 31) adjacent to the cap membrane (17 and 37) that seals the cap against the bottle transition (not pictured). Moreover, there may be a short distance between the opening of the cap 14 and 34 and the respective membrane 17 and 37. These two characteristics, particularly when combined, can make it difficult to mechanically or manually register the cap within the transition to engage the cap threads with the transition threads. This can be problematic on high speed manufacturing lines as well as for those with impaired manual dexterity.

### SUMMARY OF THE INVENTION

The present invention is directed to threaded closure assemblies that solve the aforementioned problems. The invention is also directed to the caps themselves.

The threaded closure assembly may be utilized as a bottle closure, particularly of a bottle containing a liquid composition. The threaded closure assembly comprises a cap and a transition. The cap is designed to be easily applied on a high speed manufacturing line with enough force to prevent leakage from the bottle, yet the cap is also easily opened and resealed by the consumer. This is surprisingly achieved through the particular combination of two or more of the following: multiple thread leads; high thread lead angles; a proportionally longer distance between the cap opening and cap membrane; and placing the threads near to the cap opening rather than to the cap membrane.

In one embodiment, a threaded closure assembly comprises a transition and a cylindrical cap. The transition in turn comprises a transition wall that is described by an inner and outer transition wall surface. A transition collar is attached to the transition wall. The transition collar itself comprises a transition collar rim.

The cap which is described by a longitudinal center axis comprises a closed cap top distally attached to a substantially circular cap opening via a cap wall. The cap wall is described by an inner cap wall surface and an outer cap wall surface. The outer cap wall surface has a circumference “Cₒ”. A substantially circular cap membrane is disposed on the outer cap wall surface. At least two external thread structures are also disposed on either the inner or the outer cap wall surface along the longitudinal center axis of the cap between the substantially circular cap membrane and the substantially circular cap opening. Each of the external threads has a discrete thread start disposed along the outer cap wall surface proximate to the substantially circular cap opening. Each of the external threads has a thread lead angle of from about 4 to about 45 degrees and a length less than one half of Cₒ.

The transition additionally comprises at least two internal thread structures disposed on either the inner or the outer transition wall surface. The internal threads are placed on the transition such that they are mutually engageable with the external thread structures on the cap. When the external and internal thread structures are engaged, there is a seal between the circular cap membrane and the transition collar rim. This seal may be air tight and/or liquid tight.

Another embodiment relates to a method of sealing a bottle containing a liquid with a threaded closure assembly comprising a transition and a cylindrical cap. The method comprises the following steps in any useful order:

(a) providing a bottle comprising a bottle body with a closed end and an open end which terminates in a substantially circular bottle mouth;
(b) functionally connecting the transition to the bottle mouth, wherein the transition comprises:
i. a transition wall described by an inner transition wall surface and an outer transition wall surface;
ii. a transition collar attached to the transition wall, wherein the transition collar comprises a transition collar rim; and
iii. at least two internal thread structures disposed on either the inner or the outer transition wall surface;
   (c) providing a cap being described by a longitudinal center axis, the cap comprising:
i. a closed cap top distally attached to a substantially circular cap opening via a cap wall having an inner cap wall surface and an outer cap wall surface, the outer cap wall surface having a circumference Cₒ;
ii. a substantially circular cap membrane disposed on the outer cap wall surface; and
iii. at least two external thread structures disposed on either the inner or the outer cap wall surface along the longitudinal center axis of the cap between the circular cap membrane and the cap opening, wherein each of the at least two external threads comprises:
   1. a discrete thread start disposed along either the inner or the outer cap wall surface proximate to the cap opening;
   2. a thread lead angle of from about 4.5 to about 45 degrees; and
   3. a length less than one half of Cₒ;
      (d) inserting the substantially circular cap opening into the transition; and (e) substantially rotationally engaging the external and internal thread structures by turning the cap less than 90° to form a seal between the circular cap membrane and the transition collar rim. The seal may be air tight and/or liquid tight.

### BRIEF DESCRIPTION OF THE DRAWINGS

FIG. 1 is a perspective view of the cap of a prior art threaded closure assembly.

FIG. 2 is a perspective view of a prior art threaded closure assembly on a bottle.

FIG. 3 is a perspective view of the cap of a prior art threaded closure assembly.

FIG. 4 is a perspective view of a cap per the invention.

FIG. 5 is a bottom view of a cap per the invention.

FIG. 6 is a cross-sectional view of a cap per the invention.

FIG. 7 is a perspective view of a transition per the invention.

FIG. 8 is a cross-sectional view of a transition per the invention.

FIG. 9 is a cross-sectional view of a transition per the invention.

FIG. 10 is a cross-sectional view of a threaded closure assembly per the invention.

FIG. 11 is a cross-sectional view of a threaded closure assembly per the invention.

FIG. 12 is a perspective view of a bottle per the invention.

FIG. 13 is a perspective view of a bottle per the invention.

FIG. 14 is a perspective view of comparative and inventive caps having different thread configurations.

FIG. 15 is a plot showing Off-Torque decay of multi lead threads.

### DETAILED DESCRIPTION OF THE INVENTION

As used herein, the term “Overflow Volume” is the maximum volume of liquid that a cap may hold without its contents overflowing.

As used herein, the term “Compacted” composition means a composition that water has been removed.

As used herein, the term “fluid” means any substance that is capable of being poured. Fluids of the present invention include, but are not limited to, liquids, fluidizable solids or powders, and granular compositions that are capable of being poured.

As used herein, the term “cylindrical cap” means a cap having at least a portion thereof which may be described as having the form of a cylinder or tube. “Cylindrical cap” is not meant to exclude caps comprising non-cylindrical portions, such as for example a non-cylindrical, closed cap top.

A threaded closure assembly per the present invention comprises a transition and a cylindrical cap. Optionally, the threaded closure assembly may be functionally attached to the open mouth of a bottle via a transition according to the present invention. The bottle may be sealed through the mutual engagement of the cap and transition threads.

Any one or more of the cap, transition or bottle may be made from any suitable material or combination of materials. Various plastics materials are suitable including, but not limited to polyvinyl chloride, high and low density polyethylene, polypropylene, acrylic, polystyrene, polycarbonate, polyethylene terepthalate (PET), polyethylene napthalate (PEN) and copolymers and blends of these PET and PEN in both crystalline and amorphous forms.

It is contemplated that any one or more of the cap, transition or bottle may be made using any suitable process including, but not limited to, blow molding techniques, such as stretch blow molding.

Each of the cap, transition and bottle are described in further detail below.

### Cap

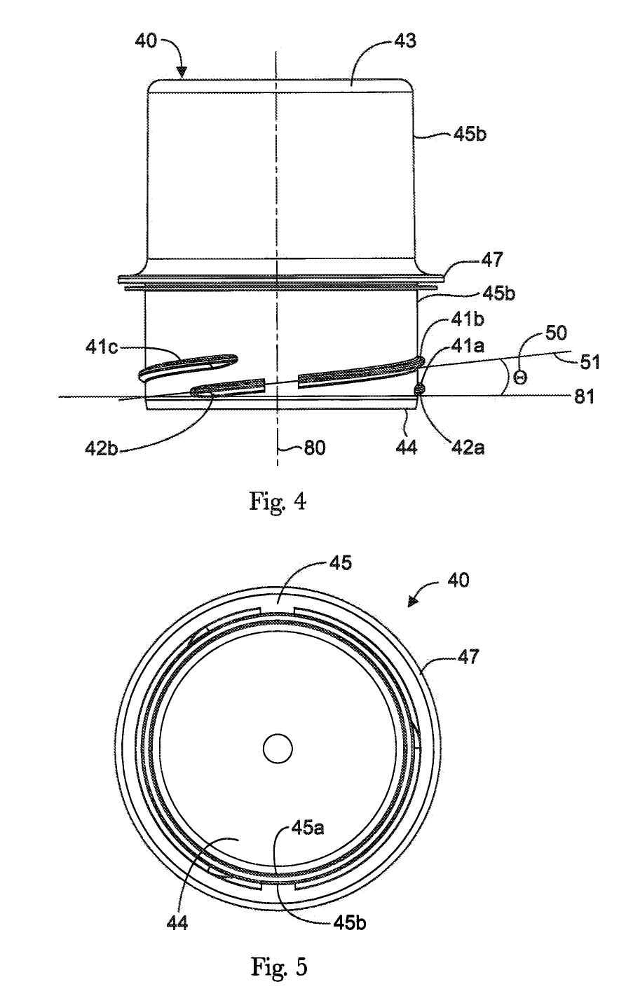

Referring to FIG. 4, the cylindrical cap 40 is described by a longitudinal center axis 80 and a line 81 orthogonal thereto. The cap has a closed top 43 that is distally attached to a substantially circular cap opening 44 via a cap wall 45. FIG. 5 presents an alternative view of the cap 40 of FIG. 4. Specifically it is a view of the bottom of the closed cap top through the substantially circular cap opening 44. Referencing FIG. 5, the cap wall 45 is described by an inner cap wall surface 45a and an outer cap wall surface 45b. The inner cap wall surface 45a has a circumference “Cᵢ” and the outer cap wall surface 45b has a circumference “Cₒ”. Referring to FIG. 4 and FIG. 5, a substantially circular cap membrane is 47 disposed on the outer cap wall surface 45b. The cap membrane may run along a circumference of the outer wall, such as along Cₒ in FIG. 5. In some embodiments, such as the one depicted in FIG. 5, the membrane is continuous.

Referring to FIG. 4, three external thread structures 41a, 41b and 41c are disposed on the outer cap wall surface 45b along the longitudinal center axis 80 of the cap 40 between the membrane 47 and the cap opening 44. In some embodiments, there are at least two thread structures. In some embodiments there are three or more thread structures. In the embodiment depicted in FIG. 4, there are three thread structures. In some embodiments, there are four or more thread structures. Each thread structure has a discrete thread start. In FIG. 4, only the discrete thread starts 42a and 42b of the thread structures 41a and 41b respectively, are visible. These thread starts are located proximate to the cap opening 44. The thread start may be less than about 5, less than about 4, less than about 3 or less than about 1 mm away from the cap opening 44.

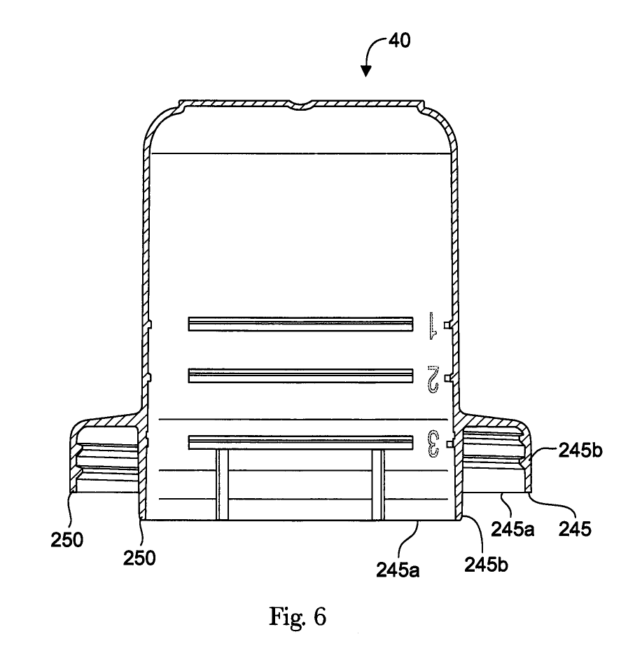

In some embodiments, the external thread structures may be disposed on an inner wall of the cap. Referring to FIG. 6, some cap embodiments may comprise a double wall 250. In these embodiments, the external threads may be disposed on an inner wall 245a of the double wall 250.

Each thread is characterized by a thread lead angle. Referring to FIG. 4, the thread lead angle 50 is the angle θ formed at the theoretical intersection of a line 51 drawn through the thread 41b with the line 81 orthogonal to longitudinal center axis 80 of the cap. Each thread on the cap may have the same or different thread lead angle. In some embodiments, each thread lead angle may have a value of from about 4 to about 45 degrees, from about 5 to about 20 degrees, from about 4.5 to about 15 degrees, from about 5.5 to about 10 degrees, or any combination of upper and lower limits, or any upper or lower limit, or any number in between the upper and lower limits. It is presently believed that that cap angles greater than 45 degrees may not be of use. Without wishing to be bound by theory, if the thread lead angle is too great, the removal torque can become so low, that the cap will simply back off on its own due to internal forces. Consequently, there is a balance to be struck with regard to thread lead angle of having an angle that is great enough to reduce off-torque, but not so great as to loose the advantage of a good seal between the cap membrane and the transition collar rim.

Each thread may have the same or different lengths. In one embodiment, all of the threads have the same length. In another embodiment, all of the threads have the same length which is less than one half of the cap outer wall circumference, Cₒ.

Each thread may be continuous or discontinuous. In some embodiments, at least one thread is continuous. In other embodiments, at least one thread is discontinuous. In some embodiments, there is a combination of continuous and discontinuous thread(s).

In some embodiments, the cap may be used to meter doses of a liquid, i.e., it may function as a dosing cap. In some embodiments, the Overflow Volume of the cap is less than about 100 ml, less than about 85 ml, less than about 75 ml, less than about 65 ml or less than about 58 ml. In some embodiments, the cap may comprise a fill line on the inner cap wall surface, on the outer cap wall surface, or on both surfaces. In some embodiments there may be multiple fill lines that reflect different composition dosing levels.

### Transition

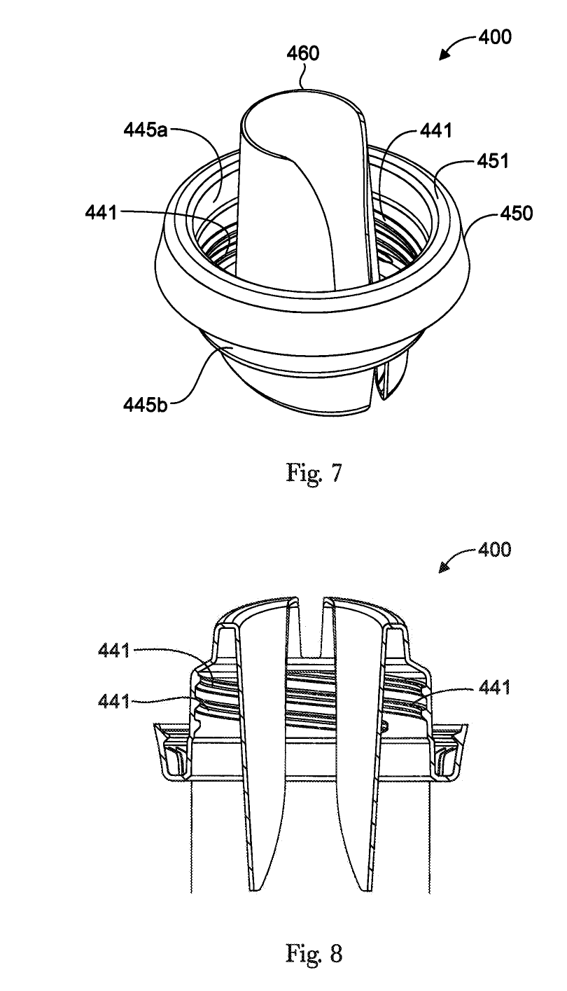

Referring to FIGS. 7, 8 and 9, the transition 400 is described by a transition wall having a transition inner wall surface 445a and a transition outer wall surface 445b. A transition collar 450 is attached to the transition wall. The transition collar has a transition collar rim 451.

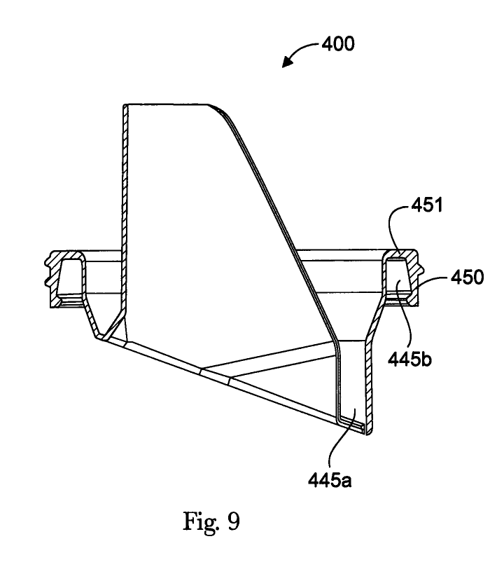

Referring to FIGS. 7 and 8, internal threads 441 are disposed on the inner wall surface. Referring to FIG. 9, the internal threads 441 are disposed on the outer wall surface 445b. The internal threads are designed to be mutually engageable with the external threads disposed on the outer cap wall surface. The number of internal threads may be the same as the number of external threads on the outer cap wall surface. In some embodiments, there are three or more thread internal structures. In some embodiments, there may be only one internal thread structure that is configured such that the external threads of a cap may engage the internal threads at multiple points. The latter embodiment is depicted in the cross-sectional view in FIG. 8, where there is one internal thread structure 441. In some embodiments, there are two or more internal thread structures.

The transition may optionally comprise a spout. Referring to FIG. 7, a spout 460 is functionally attached to the transition collar 450 via the inner wall surface 445a of the transition. When the transition is attached to a bottle, the spout may function to direct the composition that is being poured out of the bottle. For example, if the bottle contains a fluid composition, the spout functions to direct the fluid out of the bottle. Typically, the spout extends in a length beyond the collar to prevent buildup of the composition in the transition head. The spout extending beyond the collar may also aid in the pouring of the composition(s) from the bottle, particularly into a dosing cap.

In some embodiments, the transition may further comprise a drip concentrator. A drip concentrator may be concentrically interposed between the spout and the transition wall. The drip concentrator functions to gather any composition remaining in the dispensing cup upon reapplication of the cup to the transition. Suitable drip concentrators of use in the present invention are described in USPN 2009/063369.

### Threaded Closure Assembly

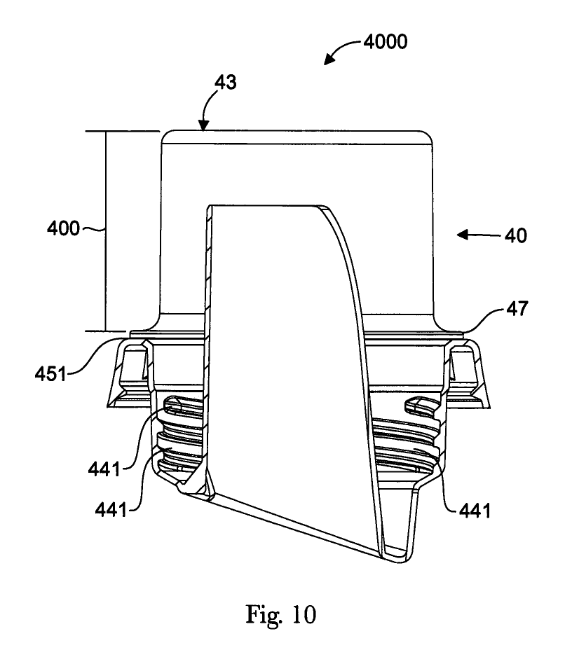

FIG. 10 illustrates one embodiment of a threaded closure assembly 4000 according to the invention. In FIG. 10, The cap 40, which comprises external threads on the outer cap wall is shown as being transparent. In the figure, the external threads of the cap (not shown) and the internal threads 441 located on the inner wall of the transition are mutually engaged such that a seal is formed between the circular cap membrane 47 and the transition collar rim 451. The seal may be air and/or liquid tight.

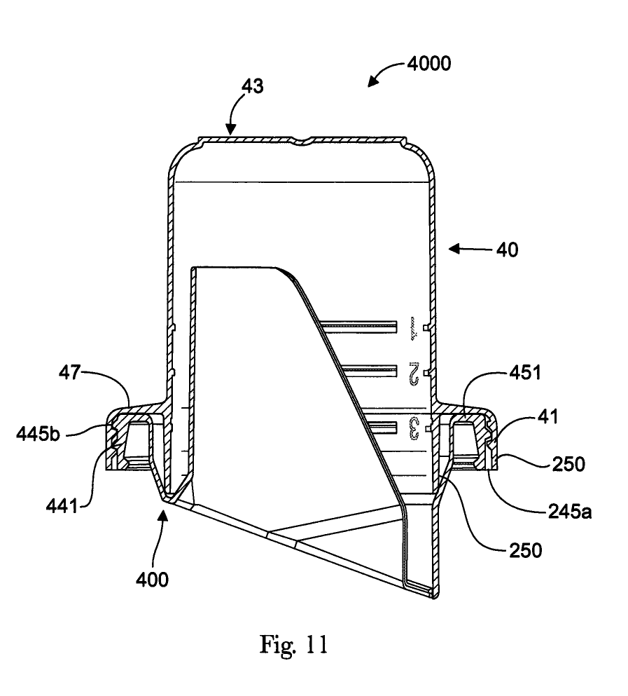

FIG. 11 illustrates a cross-sectional view of another embodiment of a threaded closure assembly according to the present invention. In FIG. 11, the cap 40, which comprises external threads 41 on the inner wall surface 245a of the double wall 250 is mutually engaged with the internal threads 441 disposed on the outer wall surface 445b of the transition 400 such that a seal is formed between the circular cap membrane 47 and the transition collar rim 451. The seal may be air and/or liquid tight.

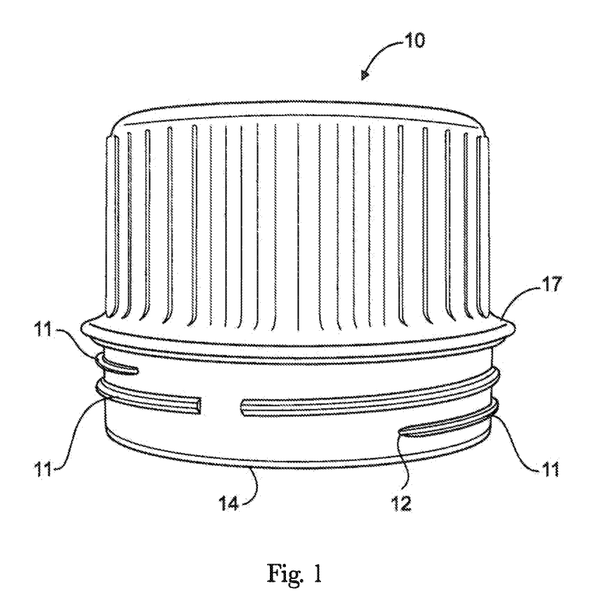

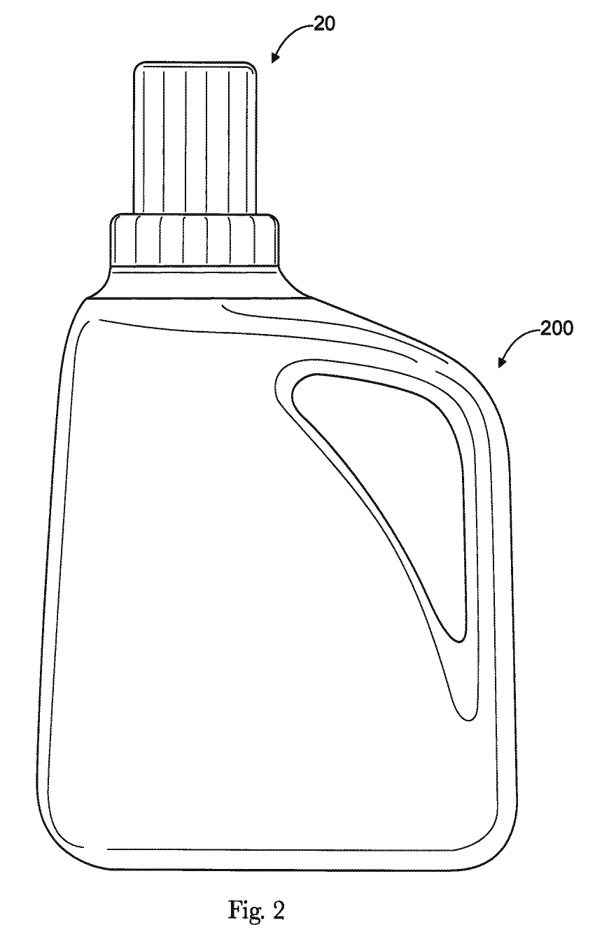

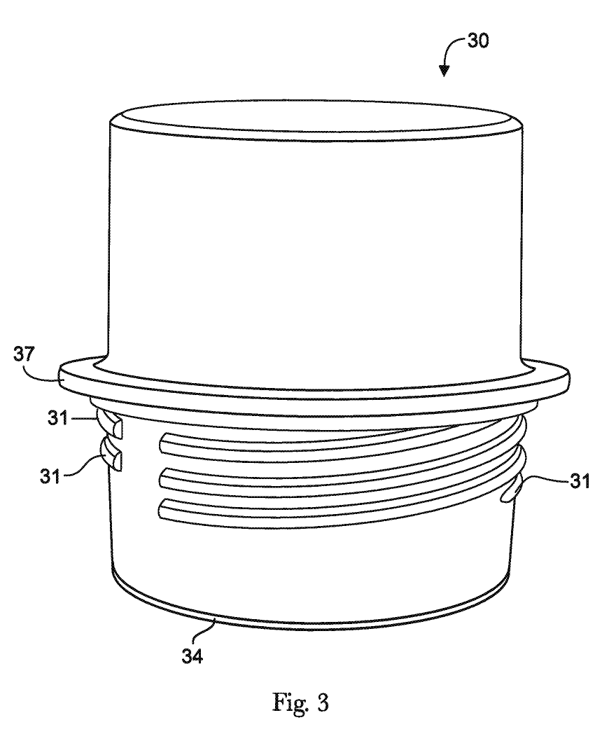

Referring to FIG. 10, when a seal is formed, the distance 480 between the transition collar rim 451 and the closed cap top 43 may be measured along the longitudinal center axis 80 of the cap. In some embodiments, this distance is less than about 40, less than about 35 or less than about 30 millimeters (mm). The longer the distance, the more the threaded closure assembly “sticks out” above the bottle to which it is attached. It is believed that distances higher than about 40, about 45 and above or about 50 mm and above are undesirable for at least three reasons. First, the higher the cap of the assembly sticks out above the bottle to which it is attached, the more storage, shipping space and display space is required. Second, a high profile cap may not be as aesthetically appealing as a lower profile one. Third, it is desirable to have more of the cap nested into the transition when it the seal is formed. In this way, the cap walls between the cap opening and the cap membrane serve as a guide for seating the cup into the transition for engagement of the external and internal threads. This is particularly advantageous over the prior art cap on a high speed assembly line, where the precise line-up of the cap and transition are necessary. As respectively shown in FIGS. 1 and 3, on the prior art caps 10 and 30, there is very little cap wall available as a guide for seating between the cap threads and cap membrane. This may result in a higher incidence of cross threading.

For any one or more of the aforementioned reasons, threaded closure assemblies of the present invention may comprise a distance along the longitudinal center axis of the cup between the transition collar rim and the closed cap top that is about three, about four, greater than about 3, or greater than about 4 more times than the distance between the substantially circular cap membrane and the substantially circular cap opening.

### Bottle

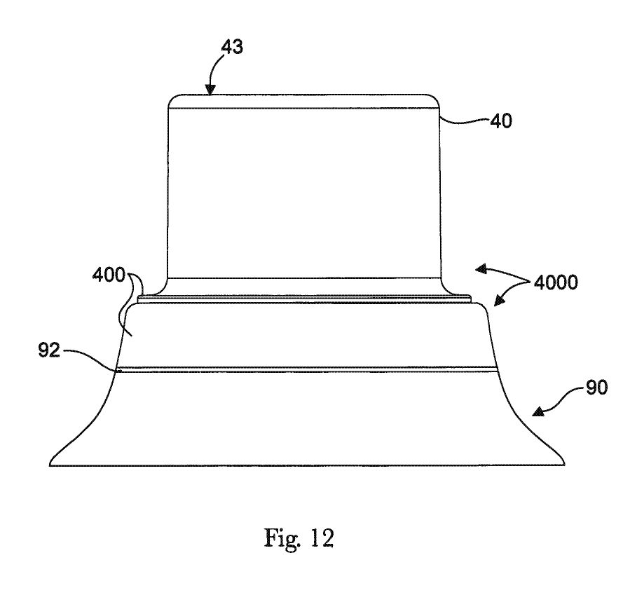

FIG. 12 illustrates one embodiment of a bottle 90 according to the invention. In this embodiment, the cap 40 comprises external threads on its outer wall surface and the transition 400 comprises internal threads on its inner wall surface (threads not shown). In this way, the outer wall of the transition remains visible when the cap and the transition are mutually engaged such that the bottle is sealed.

In FIG. 12, the bottle has a closed end (not shown) distally located from an open end 92, which terminates in a substantially circular bottle mouth (not shown). The bottle mouth is functionally attached to a threaded closure assembly 4000 according to the present invention via the transition. The attachment can be accomplished using any suitable means. Non-limiting examples of attachment means include: snapping the transition onto the bottle via a plug seal; threading the transition on with a plug seal; snapping the transition on and securing with glue; spin welding the transition onto the bottle; and combinations thereof.

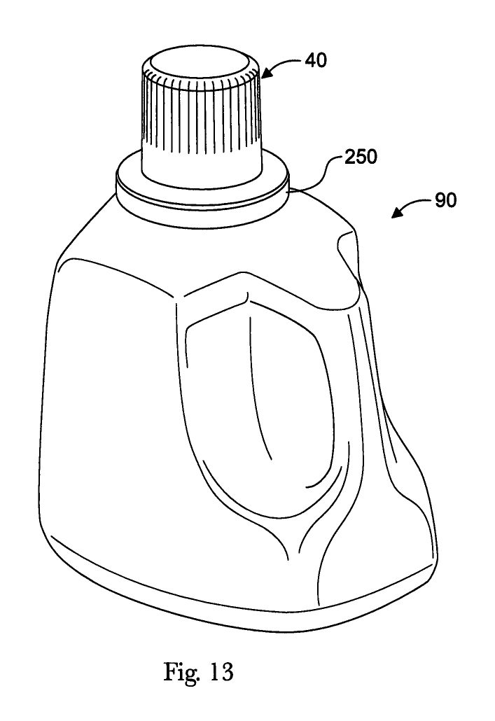

FIG. 13 illustrates another embodiment of a bottle 90 according to the invention. There are differences between the embodiment in this figure and the one in FIG. 12. Specifically, the cap 40 in FIG. 13 comprises external threads on an inner wall surface of a double wall 250 and the transition comprises internal threads on its outer wall surface (threads not shown). In this way, the outer wall of the transition is not visible when the cap and the transition are mutually engaged such that the bottle is sealed.

The bottle may be capable of containing a fluid composition. Non-limiting examples of useful fluid compositions include fluid fabric care compositions. Such compositions include, but are not limited to fabric detergent, fabric enhancer and 2-in-1 fabric detergent and enhancer compositions. In some embodiments, the fabric care composition is Compacted.

The bottle may be labeled using any suitable means. A non-limiting example is the use of a shrink sleeve that may be fitted over the bottle body. Useful means and configurations for shrink sleeving are described in USPN 2006/0141182A1, 2007/0095779A1 and US20050139568A1.

### Method

The present invention is also directed to a method of sealing a bottle containing a liquid using the present, inventive threaded closure assembly. The method steps are found at p. 1, line 30 to p. 2, line 23. For the sake of brevity, they will not be repeated here. Notably, this method allows for the reduction of Off-torque necessary for a consumer to apply to the cap the first time it is opened. Without wishing to be bound by theory, it is believed that the particular selection of multi-lead threads, having unusually high thread lead angles accomplishes at least two highly desirable results. First, the Off-torque that is necessary to apply when removing the cap from a bottle the first time is reduced as compared to caps having the same number of threads having typical thread lead angles. This is demonstrated in the Data section below. Second, less twisting motion is required to seal the bottle. Both of these aspects can be of relevance to consumers, particularly those consumers who suffer from lack of mobility due to for arthritis for example.

### Data

The Off-torque necessary for a consumer to apply to a cap the first time it is opened may be measured using the following method. A cap is applied to a transition utilizing a force that is typical of that employed in a bottle manufacturing line. The force used provides for a liquid tight seal between the cap membrane and the transition collar rim. The Off-torque required to unscrew the cap from the transition is measured using a torque gage as follows. First, the bottle is captured in a fixture while a chuck attached to a torque gage is used to remove the closure. The Off-torque is the torque at which the closure is removed.

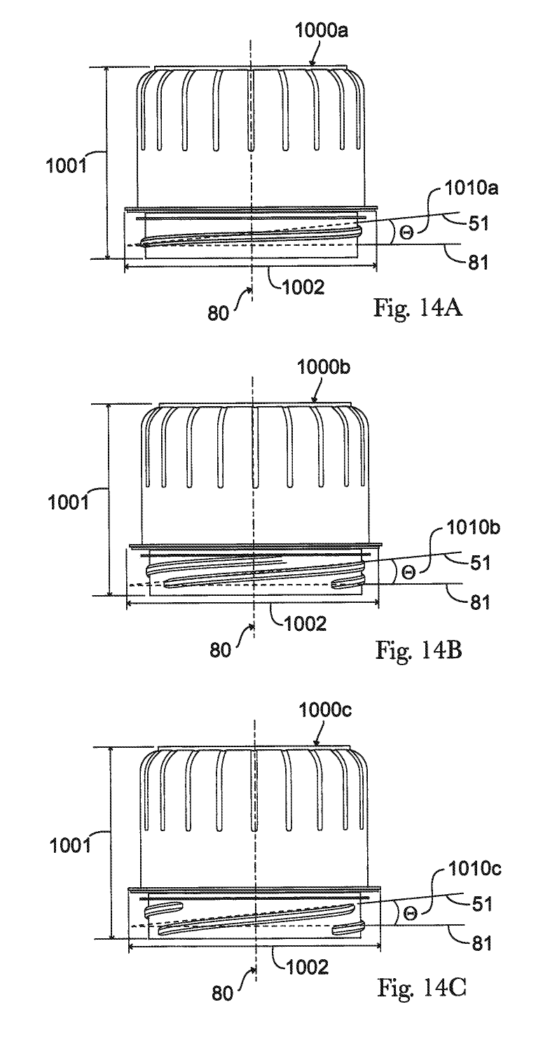

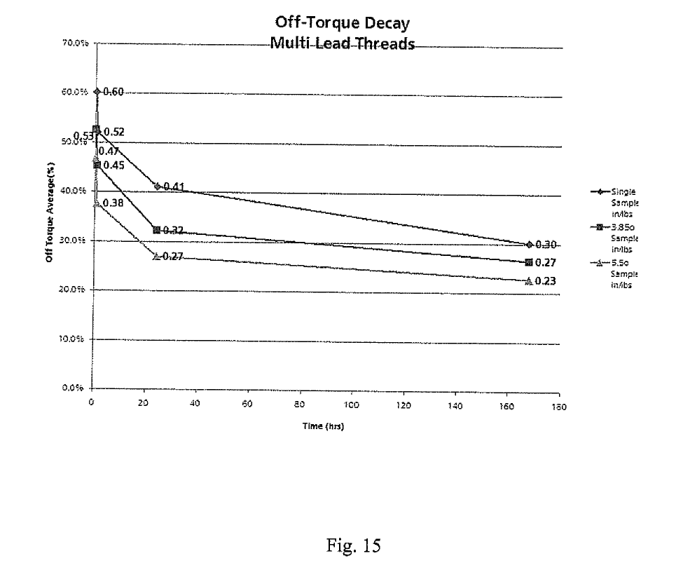

Off-torque data is collected for three caps that are identical with the exception of the thread configuration. Referring to FIG. 14, each of caps 1000 “A”, “B” and “C” have a total height 1001 of 2.175 inches and a cap opening 1002 having a diameter of 2.82 inches. Each cap is described by the angle θ formed at the theoretical intersection of a line 51 drawn through the thread 1014 a, b or c with a line 81 orthogonal to the longitudinal axis 80 of each cap. Comparative cap “A” has a single thread and thread lead; the thread lead angle 1010a is 1.8 degrees. Comparative cap “B” has three threads each having a separate thread lead and a thread lead angle 1010b of 3.85 degrees. According to the present invention, cap “C” has three threads, each with a unique thread lead and a thread lead angle 1010c of 5.50 degrees. The resulting off-torque data are plotted against time to demonstrate the Off-Torque decay of multi lead threads in the graph shown in FIG. 15:

As can be seen from FIG. 15, adding multiple threads to a cap (e.g., caps B and C) provides for lower off-torque than a single-threaded cap (e.g., cap A). Moreover, by holding the number of thread leads constant and by increasing the thread lead angle, the off-torque of the cap is reduced (see cap C vs. cap B).

Approximately 360 degrees of rotation are needed to remove Cap “A” from a transition. Approximately 160 degrees of rotation are needed to remove Cap “B” from a transition. Approximately 130 degrees of rotation are needed to remove Cap “C” from a transition.

Based upon the foregoing, it may be concluded that while the inventive cap “C” can be applied in the manufacturing facility to be liquid tight, it is easier for a consumer to remove than comparative caps “A” and “B”.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All numerical ranges disclosed herein are inclusive and combinable.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A threaded closure assembly comprising a transition and a cylindrical cap:
said transition comprising:
a transition wall described by an inner transition wall surface and an outer transition wall surface;
a transition collar attached to said transition wall, wherein said transition collar comprises a transition collar rim;
said cap being described by a longitudinal center axis, said cap comprising:
a. a closed cap top distally attached to a substantially circular cap opening via a cap wall having an inner cap wall surface and an outer cap wall surface, said outer cap wall surface having a circumference Cₒ;
b. a substantially circular cap membrane disposed on said outer cap wall surface; and
c. at least two external thread structures wherein each thread structure is either disposed on said inner or said outer cap wall surface along said longitudinal center axis between said circular cap membrane and said opening, wherein each of said at least two external threads comprises:
i. a discrete thread start disposed along said inner or said outer cap wall surface proximate to said cap opening;
ii. a thread lead angle of from about 4 to about 45 degrees; and
iii. a length less than one half of Cₒ;
wherein said transition comprises at least two internal thread structures disposed on said inner or said outer transition wall surface that are mutually engageable with said external thread structures to form a seal between said circular cap membrane and said transition collar rim.

2. The threaded closure assembly of claim 1, said cap having an Overflow Volume of less than about 85 ml.

3. The threaded closure assembly of claim 1, such that when said external thread structures and said internal thread structures are mutually engaged there is a seal between said transition collar rim and said substantially circular cap membrane and there is a distance along said longitudinal center axis of less than 40 mm between said transition collar rim and said closed cap top.

4. The threaded closure assembly of claim 3, wherein there is a distance along said longitudinal center axis between said transition collar rim and said closed cap top that is greater than about three or more times the distance between said substantially circular cap membrane and said substantially circular cap opening.

5. The threaded closure assembly of claim 1, wherein at least one of said external thread structures is continuous.

6. The threaded closure assembly of claim 1, wherein at least one of said external thread structures is discontinuous.

7. The threaded closure assembly of claim 1, said cap comprising at least one dosing line.

8. The threaded closure assembly of claim 1, said transition comprising a spout functionally attached to said transition collar via said transition wall.

9. The threaded closure assembly of claim 8, wherein a drip concentrator is concentrically interposed between said spout and said transition wall.

10. The threaded closure assembly of claim 1, wherein said at least two external threads each comprises a thread lead angle from about 4.5 to about 15 degrees.

11. A bottle comprising a bottle body with a closed end and an open end, the open end terminating in a substantially circular bottle mouth, said bottle being capable of containing a fluid composition and said bottle mouth being functionally attached to said threaded closure assembly of claim 1 via said transition.

12. The bottle of claim 11, said bottle containing a fluid fabric care composition.

13. The bottle of claim 12, wherein said fluid fabric care composition is selected from the group of liquid detergent; liquid fabric enhancer; and mixtures thereof.

14. The bottle of claim 11, further comprising a shrink sleeve fitted over the bottle body.

15. A threaded closure assembly comprising a transition and a cylindrical cap:
said transition comprising:
a transition wall described by an inner transition wall surface and an outer transition wall surface;
a transition collar is attached to said transition wall, wherein said transition collar comprises a transition collar rim;
a spout functionally attached to said transition collar via said transition wall;
and said cap having an Overflow Volume of less than about 85 ml and being described by a longitudinal center axis, said cap comprising:
a. a closed cap top distally attached to a substantially circular cap opening via a cap wall having an inner cap wall surface and an outer cap wall surface, said outer cap wall surface having a circumference Cₒ;
b. a substantially circular cap membrane disposed on said outer cap wall surface;
c. at least three discontinuous external thread structures disposed on said outer cap wall surface along said longitudinal center axis between said circular cap membrane and said opening, wherein each of said at least two discontinuous external threads comprises:
i. a discrete thread start disposed along said outer cap wall surface proximate to said cap opening;
ii. a thread lead angle of from about 4.5 to about 15 degrees; and
a length less than one half of Cₒ; and
d. and at least one fill line;
wherein said transition comprises at least two internal thread structures disposed on said inner transition wall surface that are mutually engageable with said external thread structures to form a seal between said circular cap membrane and said transition collar rim.

16. The threaded closure assembly of claim 15, such that when said external thread structures and said internal thread structures are mutually engaged such that there is a seal between said transition collar rim and said substantially circular cap membrane, there is a distance along said longitudinal center axis of less than 35 mm between said transition collar rim and said closed cap top.

17. The threaded closure assembly of claim 16, wherein there is a distance along said longitudinal center axis between said transition collar rim and said closed cap top that is greater than about three or more times the distance between said substantially circular cap membrane and said substantially circular cap opening.

18. A bottle comprising a bottle body with a closed end and an open end, the open end terminating in a substantially circular bottle mouth, said bottle being capable of containing a fluid composition and said bottle mouth being functionally attached to said threaded closure assembly of claim 15 via said transition.

19. A method of sealing a bottle containing a liquid with a threaded closure assembly comprising a transition and a cylindrical cap, said method comprising the steps of:
a. providing a bottle comprising a bottle body with a closed end and an open end, said open end terminating in a substantially circular bottle mouth;
b. functionally connecting said transition to said bottle mouth, said transition comprising:
i. a transition wall described by an inner transition wall surface and an outer transition wall surface;
ii. a transition collar is attached to said wall, wherein said transition collar comprises a transition collar rim; and
iii. at least two internal thread structures disposed on said inner or outer transition wall surface;
c. providing a cap being described by a longitudinal center axis, said cap comprising:
i. a closed cap top distally attached to a substantially circular cap opening via a cap wall having an inner cap wall surface and an outer cap wall surface, said outer cap wall surface having a circumference Cₒ;
ii. a substantially circular cap membrane disposed on said outer cap wall surface; and
iii. at least two external thread structures wherein each thread structure is either disposed on said inner or said outer cap wall surface along said longitudinal center axis between said circular cap membrane and said cap opening, wherein each of said at least two external threads comprises:
1. a discrete thread start disposed along said inner or said outer cap wall surface proximate to said cap opening;
2. a thread lead angle of from about 4 to about 45 degrees; and
3. a length less than one half of Cₒ;
d. inserting said substantially circular cap opening into said transition; and
e. rotationally engaging said external and internal thread structures by turning said cap about 180° or less to form a seal between said circular cap membrane and said transition collar rim.

20. The method of claim 19, wherein: three thread structures are disposed on said inner transition wall surface; three external thread structures are disposed on said outer cap wall surface along said longitudinal center axis between said circular cap membrane and said cap opening; and said cap is turned about 120° or less to form a seal.
